(19) United States
(12) Patent Application Publication
(10) Pub. No.: US 2023/0347742 A1
(43) Pub. Date: Nov. 2, 2023

(54) Cabin Power Distribution Systems and Methods

(71) Applicant: Safran Passenger Innovations, LLC, Brea, CA (US)

(72) Inventors: Joseph Rhoads Winston, Yorba Linda, CA (US); Matthew Gledich, Mission Viejo, CA (US)

(73) Assignee: Safran Passenger Innovations, LLC, Brea, CA (US)

(21) Appl. No.: 17/814,008

(22) Filed: Jul. 21, 2022

Related U.S. Application Data
(60) Provisional application No. 63/336,983, filed on Apr. 29, 2022.

(51) Int. Cl. B60L 1/00; B60L 1/16; B60R 16/023; B60R 16/03

(52) U.S. Cl. CPC B60L 1/006; B60L 1/16; B60R 16/0238; B60R 16/03; B60L 2200/10

(57) ABSTRACT

Vehicle power distribution systems are described comprising one or more advanced master control units in electrical communication with a vehicle power source. The advanced master control unit is configured to receive the vehicle current and generate a first current in response to the vehicle current. Power outlets and/or data ports may be in electrical communication with the advanced master control unit, such that they can receive the first current. The system may also have a simple power supply that can receive the first current and convert this to a second current, which can be used to power in-flight entertainment devices and other components of the vehicle.

This application claims priority to U.S. provisional patent application having Ser. No. 63/336,983 filed on Apr. 29, 2022. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is power distribution in vehicle cabins.

### BACKGROUND

The following description includes information that may be useful in understanding the present invention. It is not an admission that any of the information provided herein is prior art or relevant to the presently claimed invention, or that any publication specifically or implicitly referenced is prior art.

Aircraft power distribution systems generally rely on a power supply or box at each seat or seat group (e.g., seat row) to distribute power to one or more in-flight entertainment system units (e.g., a seat back unit), one or more alternating current (AC) power outlets, and/or one or more USB power outlets. As shown in FIGS. 1A-1B, power can be fed to one or more Advanced Master Control Units (AMCUs) 110, which then distributes power through multiple columns to a plurality of power supplies 120 distributed through the aircraft 102. The power is typically three-phase power at 115 VAC. The frequency can vary depending on the aircraft but is generally between 380-800 Hz.

Each of the power supplies 120 can reduce the voltage and/or frequency of the received power as needed, depending on the application. For example, the power supply 120 can feed power to one or more AC power outlets 130 at a reduced voltage of 110 VAC and a frequency of 50 Hz, while also converting some of the received power to direct current (DC) at 28 VDC when distributing to one or more USB power outlets 132 and/or one or more in-flight entertainment system units 134. The power supply 120 can also supply power to one or more light sources 136 that may indicate a status of the A/C power outlet 130, the USB port 132 and/or the seatgroup level.

Power supply 120 offers galvanic isolation but generally requires power input testing since it is connected directly to the aircraft power. In addition, the requirement for larger power supplies at each seat group adds to the overall space and weight requirements of the system.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for improved power distribution systems that eliminate the need for seat-specific power supplies or reduce the overall footprint of the seat-specific power supplies when in-flight entertainment units are utilized at seat locations.

### SUMMARY OF THE INVENTION

The inventive subject matter provides apparatus, systems, and methods for power distribution within an aircraft or other vehicle which can be used to power a plurality of power outlets and/or aircraft devices. Contemplated vehicles include, for example, aircraft, busses, trains, cars, ferries, and other boats. The power outlets could be used by passengers or crew to power one or more portable computing devices, for example.

As used herein, the term “portable computing device” is defined to include laptop computers, tablet PCs, smart phones including, for example, those running APPLE iOS™ or ANDROID™ operating software, smart watches, smart glasses such as GOOGLE glass or their equivalent capable of displaying augmented reality elements to a user wearing the glasses.

Contemplated power distribution systems for a vehicle comprise one or more advanced master control units—AMCUs—configured to receive an aircraft current from an aircraft power source. Each AMCU is preferably in electrical communication with the aircraft power source and is configured to receive the aircraft current. The AMCU preferably generates a first current in response to the aircraft current.

One or more power outlets are in electrical communication with the advanced master control unit and configured to receive the first current. As discussed above, the power outlets can be used by passengers or other persons to provide power to a portable computing device or another device that can be charged using the power outlet. In some embodiments, the power outlets can receive the first current which has a voltage of 110 VAC and a frequency of 50 Hz. Of course, the specific voltage and frequency may vary depending on the application.

Advantageously, a separate power supply is not required near or at the seat location where the power outlet is disposed to provide power from the AMCU to the power outlet, which can greatly reduce the space and weight required for power distribution within the aircraft or other vehicle. Instead, appropriate power can be fed directly into intelligent AC power outlet units (ACOUs). It is contemplated that direct current power can be generated by the ACOU, rather than a separate power supply, when a USB or alternative power port is required. This provides for a great simplification of the development and certification process for the system and may eliminate the need for any major underfloor wiring changes to some vehicle's architecture.

In some embodiments, a simple seat-centric or seat-group centric power supply (simple power unit) can be disposed at a seat group within the vehicle. The simple power supply is configured to receive the first current from the AMCU and generate a second current in response to the first current. The first current has a second voltage and a second frequency, and the second current has a third voltage and a third frequency. Typically, the third voltage is less than the second voltage.

One or more aircraft devices can be in electrical communication with the simple power supply and configured to receive the second current from the simple power supply. In such embodiments, it is contemplated that the first current is different than the second current. For example, the third voltage may be less than the first voltage and less than the second voltage. As another example, the third voltage may comprise a direct current having a voltage of approximately 28 VDC while the second current may comprise an alternating current having a voltage of approximately 110 VAC.

The aircraft devices may comprise a universal serial bus (USB) port, an in-use light, an in-flight entertainment system, or combinations thereof. In-flight entertainment systems may include a seat display unit having a display screen configured to display content to a passenger, for example.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A is a schematic of a prior art power distribution system.

FIG. 1B is a schematic of another prior art power distribution system.

FIG. 2 is a schematic of one embodiment of a power distribution system.

FIG. 3 is a schematic of another embodiment of a power distribution system.

FIG. 4 is a schematic of another embodiment of a power distribution system.

FIG. 5 is a schematic of another embodiment of a power distribution system.

FIG. 6 is a schematic of another embodiment of a power distribution system.

FIG. 7 is a schematic of another embodiment of a power distribution system.

FIG. 8 is a schematic of another embodiment of a power distribution system.

### DETAILED DESCRIPTION

Throughout the following discussion, references may be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

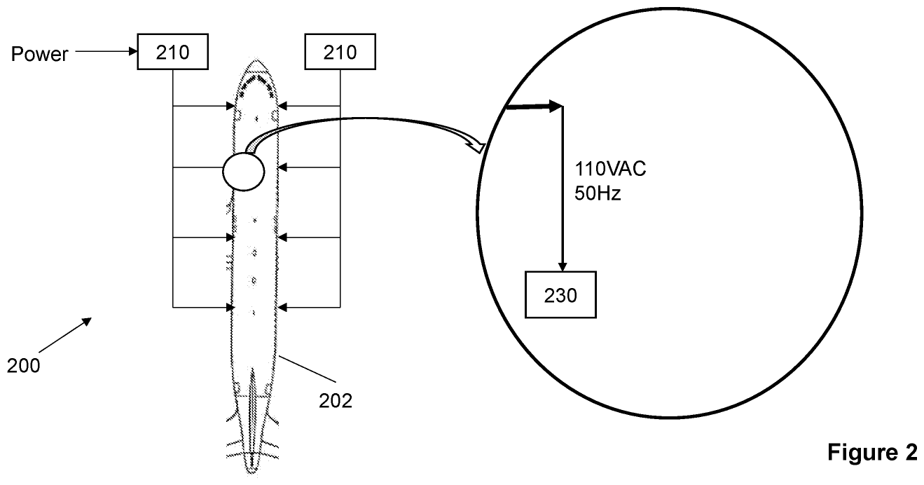

FIG. 2 illustrates one embodiment of a power distribution system 200 for an aircraft 202. Aircraft power can be distributed to one or more AMCUs 210 from an aircraft power source providing an aircraft current. In some embodiments, the aircraft current comprises three-phase power at approximately 115 VAC. The specific frequency will likely vary depending on the aircraft or other vehicle, but may range between 300-1,000 Hz, and more preferably between 350-850 Hz. The AMCUs 210 are in electrical communication with the aircraft power source. The AMCUs 210 are configured to receive the aircraft current and generate a first current in response to the aircraft current, preferably also three-phase power. It is preferred that the AMCU 210 ensures the aircraft current and the first current are in galvanic isolation from one another.

As shown in FIG. 2, the first current can be distributed throughout the aircraft along one or more columns directly to a plurality of power outlets 230 without the need for a separate power supply at each seat or seat group. Each power outlet 230 is in electrical communication with one of the AMCUs 210 such that each of the power outlets 230 receive the first current. It is preferred that each seat row of the aircraft 202 may have at least one power outlet 230. Thus, for an aircraft having 30 rows of seats, it is contemplated that there may be 30, 60, or more power outlets 230 disposed within the vehicle 202, depending on the number of power outlets 230 disposed at each seat row or group.

As shown the first current preferably has a voltage of 110 VAC at a frequency of 50 Hz. Of course, the specific properties of the current may vary depending on the application.

Although the above description has referenced aircraft, it is contemplated that the power distribution system 200 could be implemented in other vehicles such as those described above.

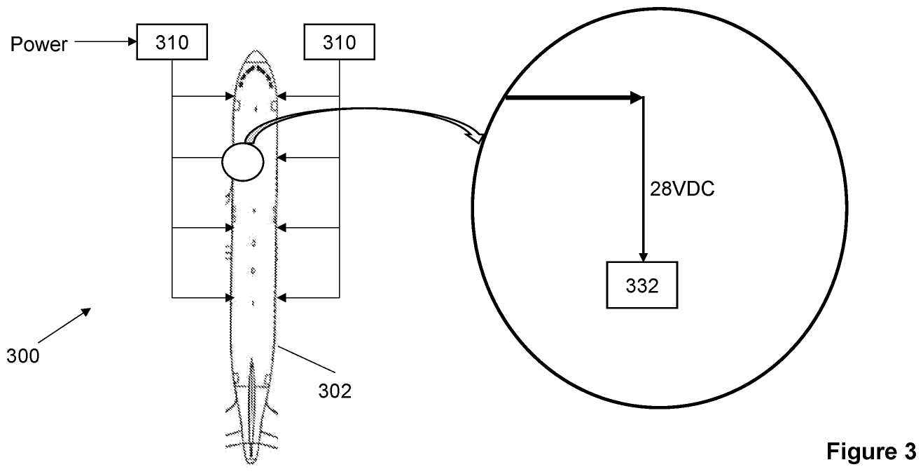

FIG. 3 illustrates another embodiment of a power distribution system 300 for an aircraft 302. Similar to FIG. 2, aircraft power can be distributed to one or more AMCUs 310 that are in electrical communication with an aircraft power source providing an aircraft current. It is contemplated that the aircraft power may have the same properties as described above. The AMCUs 310 are configured to receive the aircraft current and generate a first current in response to the aircraft current. It is preferred that the AMCU 310 ensures the aircraft current and the first current are in galvanic isolation from one another.

The first current can be distributed throughout the aircraft to a plurality of universal serial bus (USB) or other data or power ports 332 that are in electrical communication with one of the AMCUs 310 such that the data or power ports 332 receive the first current without the need for a separate power supply at each seat or seat group. It is preferred that each seat row or group of the aircraft 302 may have at least one data or power port 332, and in some cases, each seat may include at least one data or power port 332. As shown, the first current preferably comprises a direct current with a voltage of 28 VDC. Of course, the specific properties of the current may vary depending on the application.

Although the above description has referenced aircraft, it is contemplated that the power distribution system 300 could be implemented in other vehicles such as those described above.

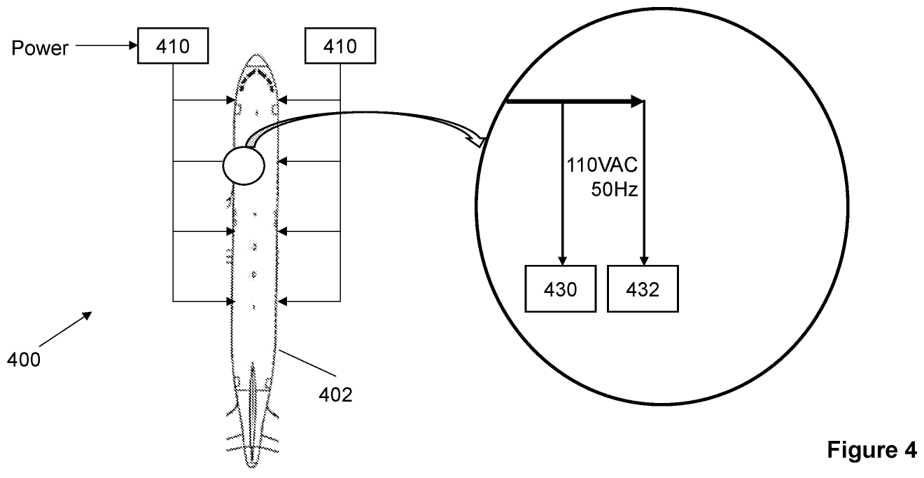

FIG. 4 illustrates another embodiment of a power distribution system 400 for an aircraft 402. Aircraft power can be distributed to one or more AMCUs 410 that are in electrical communication with an aircraft power source providing an aircraft current. It is contemplated that the aircraft power may have the same properties as described above. The AMCUs 410 are configured to receive the aircraft current and generate a first current in response to the aircraft current. It is preferred that the AMCU 410 ensures the aircraft current and the first current are in galvanic isolation from one another.

The first current can be distributed throughout the aircraft to (i) a plurality of power outlets 430 that are in electrical communication with one of the AMCUs 410 and (ii) a plurality of data or power ports 432 that are in electrical communication with one of the AMCUs 410, such that both the plurality of power outlets 430 and the plurality of data or power ports 432 receive the first current without the need for a separate power supply at each seat or seat group. Each seat or seat row/group of the aircraft 402 may have at least one data or power port 432 and/or at least one power outlet 430. As shown, the first current preferably comprises an alternating current with a voltage of 110 VAC at a frequency of approximately 50 Hz. Of course, the specific properties of the current may vary depending on the application.

In some contemplated embodiments, at least some of the power outlets 430 may comprise intelligent AC power outlet units (ACOUs), which can convert the received AC power to DC power for use by USB or other data ports 432. In such embodiments, the first current would flow to power outlets 430, which would convert the received first current into a second current that is fed to the data ports 432. In such embodiments, it is contemplated that the second current may comprise a direct current with a voltage of 28 VDC, although the specific properties of the current may vary depending on the application.

Although the above description has referenced aircraft, it is contemplated that the power distribution system 400 could be implemented in other vehicles such as those described above.

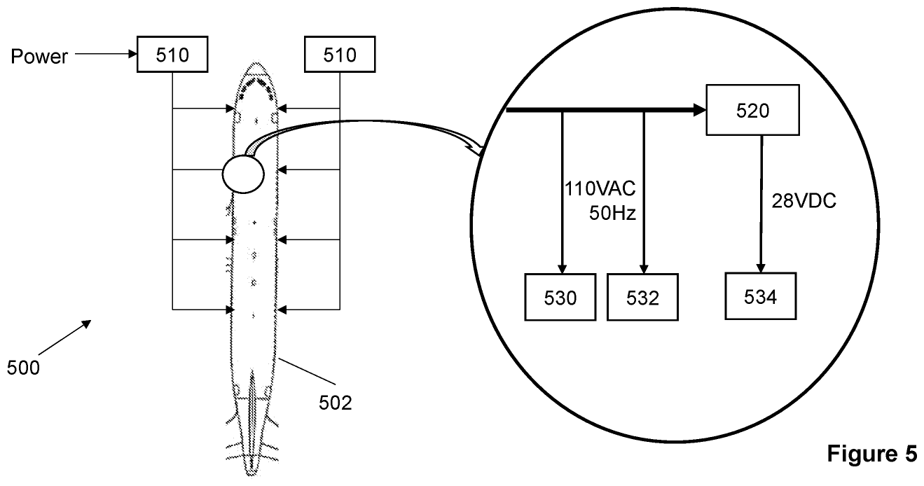

FIG. 5 illustrates another embodiment of a power distribution system 500 for an aircraft 502. Aircraft power can be distributed to one or more AMCUs 510 that are in electrical communication with an aircraft power source providing an aircraft current. It is contemplated that the aircraft power may have the same properties as described above. The AMCUs 510 are configured to receive the aircraft current and generate a first current in response to the aircraft current. The first current preferably comprises three phase power. It is preferred that the AMCU 510 ensures the aircraft current and the first current are in galvanic isolation from one another. In this manner, the galvanic isolation point can be moved from a local power supply disposed at the seat or seat group to a central AMCU 510.

The first current can be distributed throughout the aircraft to (i) a plurality of power outlets 530 that are in electrical communication with one of the AMCUs 510 and (ii) a plurality of data or power ports 532 that are in electrical communication with one of the AMCUs 510, such that both the plurality of power outlets 530 and the plurality of data or power ports 532 receive the first current. Each seat or seat row/group of the aircraft 502 may have at least one data or power port 532 and/or at least one power outlet 530. As shown, the first current preferably comprises an alternating current with a voltage of 110 VAC at a frequency of approximately 50 Hz. Of course, the specific properties of the current may vary depending on the application.

In some contemplated embodiments, at least some of the power outlets 530 may comprise intelligent AC power outlet units (ACOUs), which can convert the received AC power to DC power for use by USB or other data ports 532. In such embodiments, the first current would flow to power outlets 530, which would convert the received first current into a second current that is fed to the data ports 532. In such embodiments, it is contemplated that the second current may comprise a direct current with a voltage of 28 VDC, although the specific properties of the current may vary depending on the application.

In vehicles having components 534 of an in-flight or in-vehicle entertainment system requiring power at seatbacks or other locations within the vehicle, for example, it is contemplated that the first current can further be distributed to one or more simply power units or power supplies 520, which can be used to convert the first current to a second current. In the embodiment shown in FIG. 5, the simple power supply 520 converts the first current to a direct current having a voltage of 28 VDC. This direct current can then be used to power the in-flight entertainment component 534, which may comprise a seat back unit (SBU) having a display screen for displaying content to a passenger. The power supply 520 could power other devices or components as needed (including the USB or other data ports 532), especially those requiring a direct current at a lower voltage.

It is preferred that the power supply 520 ensures the first current and the second current are in galvanic isolation from one another.

Although the above description has referenced aircraft, it is contemplated that the power distribution system 500 could be implemented in other vehicles such as those described above.

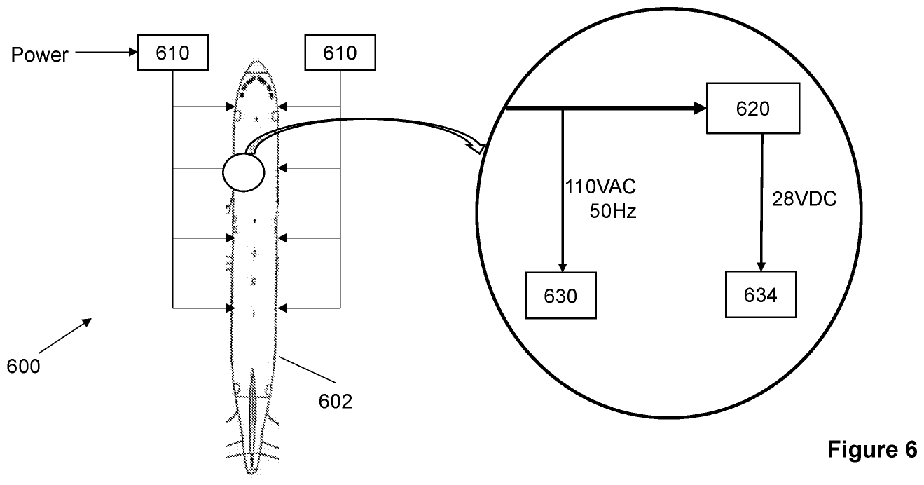

FIG. 6 illustrates another embodiment of a power distribution system 600 for an aircraft 602. The system 600 is similar to that shown in FIG. 5 except that the system 600 does not provide power to universal serial bus (USB) or other data ports.

As in the above systems, aircraft power can be distributed to one or more AMCUs 610 that are in electrical communication with an aircraft power source providing an aircraft current. It is contemplated that the aircraft power may have the same properties as described above. The AMCUs 610 are configured to receive the aircraft current and generate a first current in response to the aircraft current. It is preferred that the AMCUs 610 ensures the aircraft current and the first current are in galvanic isolation from one another.

The first current can be distributed throughout the aircraft to a plurality of power outlets 630 distributed throughout the aircraft and that are in electrical communication with one of the AMCUs 610, such that the plurality of power outlets 630 receive the first current. It is contemplated thought not required that each seat or seat row/group of the aircraft 602 have at least one power outlet 630. As shown, the first current preferably comprises three phase power having an alternating current with a voltage of 110 VAC at a frequency of approximately 50 Hz. Of course, the specific properties of the first current may vary depending on the application.

Like the system shown in FIG. 5, the system 600 can further be distributed to one or more simply power units or supplies 620, which can be used to convert the first current to a second current. The simple power supply 620 converts the alternating first current to a direct current (second current) having a voltage of 28 VDC, which can be used to power in-flight entertainment components 634 of an in-flight or in-vehicle entertainment system that may comprise a seat back unit (SBU) having a display screen for displaying content to a passenger, for example.

Although the above description has referenced aircraft, it is contemplated that the power distribution system 600 could be implemented in other vehicles such as those described above.

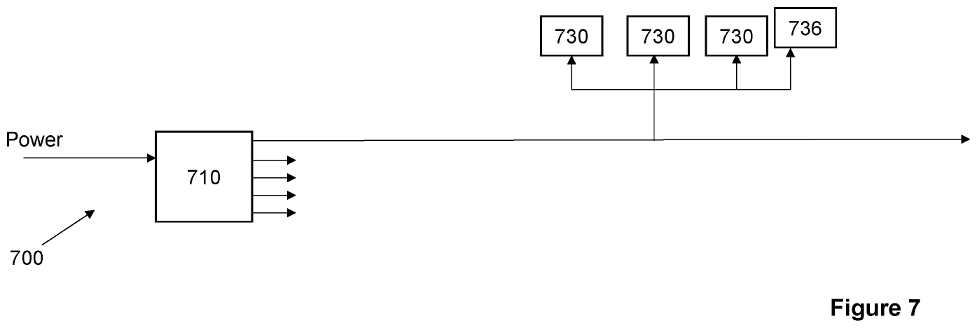

FIG. 7 illustrates another embodiment of a power distribution system 700 for a vehicle. As shown, power can be distributed to at least one AMCU 710 that is in electrical communication with a vehicle power source providing a vehicle current. It is contemplated that the power source can provide a three-phase power at approximately 115 VAC. In some embodiments, it is contemplated that the frequency could be between 300-1000 Hz. However, the specific frequency and the voltage will depend on the vehicle and other factors.

The AMCU 710 is configured to receive the vehicle current and generate a first current by converting the vehicle current. It is preferred that the vehicle current and the first current are in galvanic isolation from one another. In some embodiments, the first current could have a voltage of approximately 110 VAC with a frequency of between 30-60 Hz, and preferably at approximately 50 Hz. Of course, the specific properties of the first current may vary depending on the application. The AMCU 710 preferably produces a three-phase power using tri-state discrete logic. The AMCU 710 can provide for a master system cutoff of power to the individual seats or seatgroups, configurable current limits, and/or GFI protection, for example.

The first current can be distributed along multiple columns throughout the vehicle to a plurality of power units 730 that each comprise one or more outlets. In some contemplated embodiments, each power unit could comprise a standard plug outlet (e.g., US or European standard outlets) as well as including one or more USB or other data or power ports.

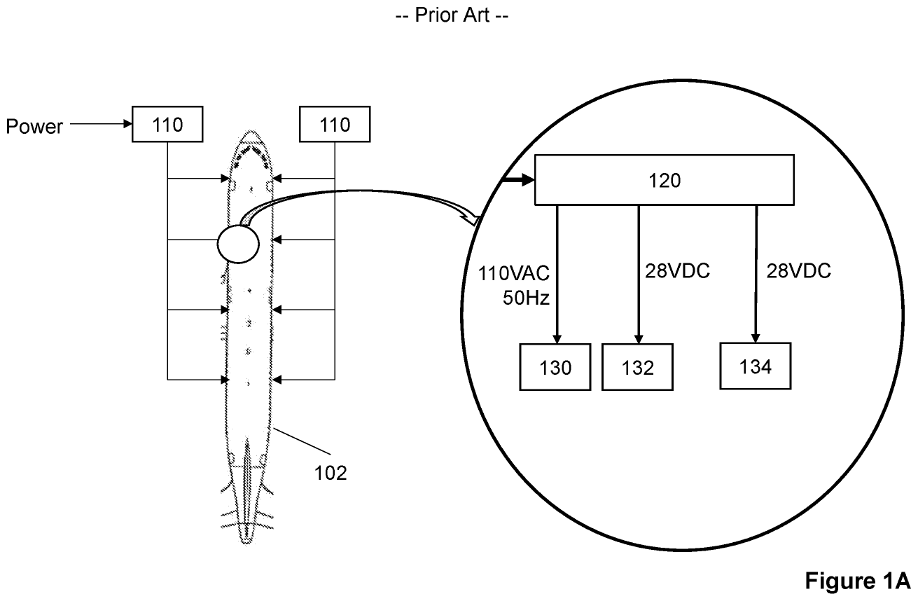

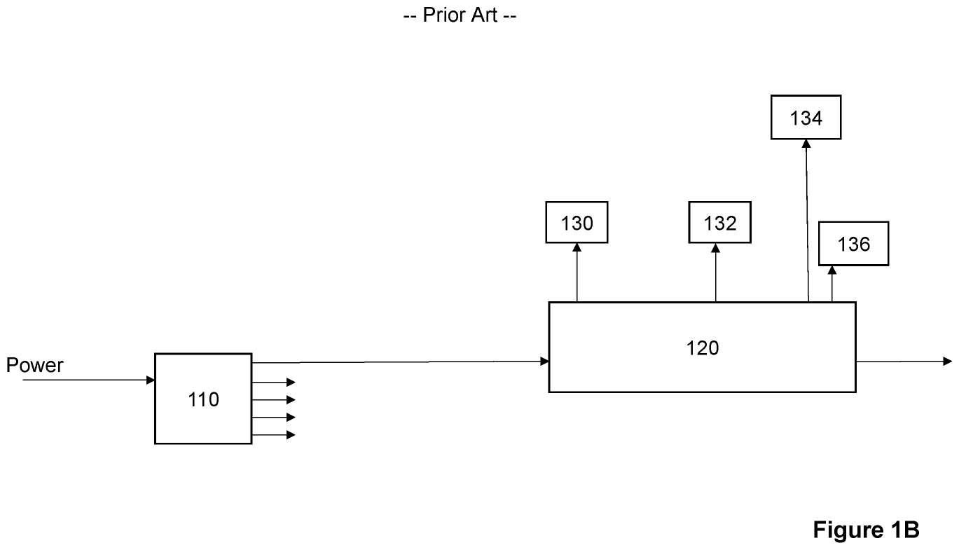

Advantageously, each power unit 730 can be configured to convert the received alternating first current from the AMCU 710 to a second current. The second current may be a direct current power to permit charging through the USB or other ports. This eliminates the need for a separate power supply at each seat group such as shown in FIGS. 1A-1B, which would otherwise be needed to convert the incoming current. It is contemplated that the second current could have a voltage of approximately 28 VDC.

The first current can further be used to power one or more in-use lights 736 or other components of the vehicle. The in-use lights (IUL) can be used to indicate a status of the power unit 730, the USB or other port, and/or the seat-group level, for example.

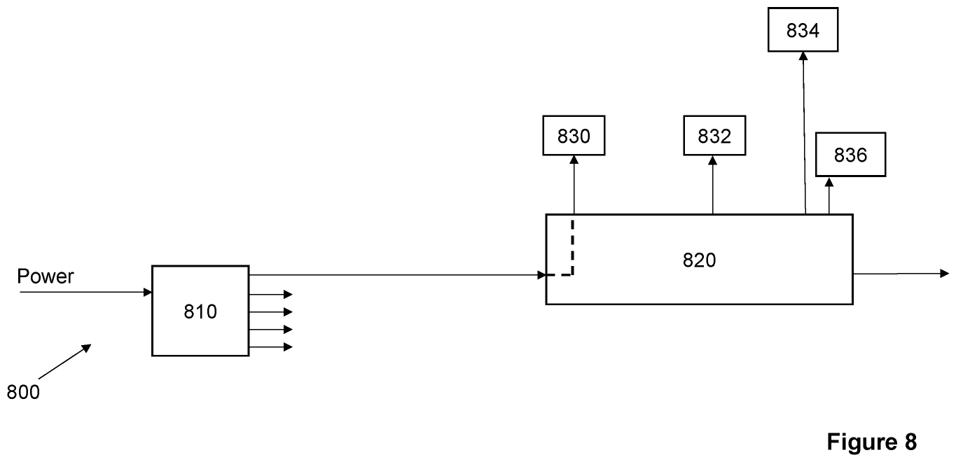

In an alternative embodiment shown in FIG. 8, another embodiment of a power distribution system 800 is shown. An in-line power can be distributed to one or more AMCUs 810 that are in electrical communication with a vehicle power source providing a vehicle current. In some embodiments, it is contemplated that the in-line power has a voltage of approximately 115 VAC with a frequency between 300-1,000 Hz and more preferably, between 350-850 Hz. Of course, the specific voltage and frequency will depend on the specific application.

The AMCUs 810 are configured to receive the vehicle current and generate a first current in response to the vehicle current. It is preferred that the AMCUs 810 ensures the vehicle current and the first current are in galvanic isolation from one another. In some embodiments, the first current preferably comprises an alternating current with a voltage of 110 VAC at a frequency of approximately 50 Hz. Of course, the specific properties of the current may vary depending on the application.

The AMCU 810 can provide for a master system cutoff of power to the individual seats or seatgroups, configurable current limits, and/or GFI protection, for example. In addition, the AMCU 810 can produce three-phase power using tri-state discrete logic.

The first current can be distributed throughout the aircraft to one or more simple power units 820, which may be disposed at each seat group of the vehicle. Each simple power unit 820 can be configured to convert the first current to a second current. For example, the simple power unit 820 may convert the first current to a lower voltage and/or to a direct current for use by one or more in-flight entertainment units 834 and/or one or more USB or other data ports 832, which may not operate at the first current. In some embodiments, the simple power unit 820 may convert the first current to a direct current with a voltage of 28 VDC with some holdup time. Power to the one or more USB or other data ports 832 may also be supplied as a direct current with a voltage of 28 VDC with no holdup. It is contemplated that the data ports 832 may be controlled via the tri-state circuitry.

The second current can further be used to power one or more in-use lights 836 or other components of the vehicle. The in-use lights (IUL) can be used to indicate a status of the power unit 830, the USB or other port, and/or the seat-group level, for example.

The simple power unit 820 allows for the pass through of the first current without conversion to allow the first current to be distributed to a plurality of power outlets 830 that are in electrical communication with one of the AMCUs 810.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A vehicle power distribution system, comprising:
an aircraft power source providing an aircraft current;
an advanced master control unit in electrical communication with the power source, the advanced master control unit configured to receive the aircraft current and generate a first current in response to the aircraft current, wherein the aircraft current and the first current are in galvanic isolation from one another; and
a power outlet in electrical communication with the advanced master control unit, wherein the power outlet is configured to receive the first current.

2. (canceled)

3. The vehicle power distribution system of claim 1, wherein the aircraft current has a first voltage and a first frequency and wherein the first current has a second voltage and a second frequency.

4. The vehicle power distribution system of claim 3, wherein the first frequency is between 300 hertz to 1000 hertz and the second frequency is between 30 hertz to 60 hertz.

5. The vehicle power distribution system of claim 3, wherein the first voltage is greater than the second voltage.

6. The vehicle power distribution system of claim 1, wherein the power outlet comprises an AC power outlet or a universal serial bus port.

7. The vehicle power distribution system of claim 1, further comprising:
a power supply disposed at a seat group configured to receive the first current and generate a second current in response to the first current; and
an aircraft device in electrical communication with the power supply, wherein the aircraft device is configured to receive the second current, and wherein the first current is different than the second current.

8. The vehicle power distribution system of claim 7, wherein the first current has a second voltage and a second frequency and wherein the second current has a third voltage and a third frequency.

9. The vehicle power distribution system of claim 8, wherein the third voltage is less than the first voltage and is less than the second voltage.

10. The vehicle power distribution system of claim 7, wherein the first current comprises alternating current and the second current comprises direct current.

11. The vehicle power distribution system of claim 7, wherein the third voltage is in an amount of 28 volts and the second voltage is in an amount of 110 volts.

12. The vehicle power distribution system of claim 1, wherein the first current is substantially the same as the aircraft current.

13. The vehicle power distribution system of claim 7, wherein the first current and the second current are in galvanic isolation from one another.

14. The vehicle power distribution system of claim 7, wherein the aircraft device comprises a universal serial bus port, an in-use light, an in-flight entertainment system, or combinations thereof.

15. The vehicle power distribution system of claim 7, wherein the aircraft device is configured to operate at the second current, but not at the first current.
